(19) United States
(12) Patent Application Publication
(10) Pub. No.: US 2017/0316080 A1
(43) Pub. Date: Nov. 2, 2017

(54) AUTOMATICALLY GENERATED EMPLOYEE PROFILES

(71) Applicant: QUEST SOFTWARE INC., ALISO VIEJO, CA (US)

(72) Inventors: Michel Albert Brisebois, Renfrew (CA); Bahar Ghadiri Bashardoost, Toronto (CA); Gabriel M. Silberman, Austin, TX (US); Cheryl Morris, Niagara-on-the-Lake (CA); Kelly Lyons, Toronto (CA); Jessica Perrie, Halifax (CA)

(21) Appl. No.: 15/142,351

(22) Filed: Apr. 29, 2016

(51) Int. Cl. G06F 17/30; G06N 99/00; G06N 7/00; G06F 7/08; G06F 17/27; G06F 17/21; G06Q 10/10

(52) U.S. Cl. CPC G06F 17/30598; G06Q 10/105; G06N 99/005; G06N 7/005; G06F 17/30864; G06F 7/08; G06F 17/30011; G06F 17/278; G06F 17/214; G06F 17/3053

(57) ABSTRACT

Systems and techniques for determining an expertise of an employee in an enterprise are described. A crawler may examine one or more external data sources that are external to an enterprise network associated with the enterprise to identify one or more documents associated with the employee. The external data sources may include patent databases, technical paper databases, and the like. A classifier may be used to determine keywords in the one or more documents. For each of the keywords, a term frequency-inverse document frequency (TF-IDF) value may be determined. The keywords may be ranked based at least in part on the TF-IDF value associated with each keyword to create ranked keywords. The ranked keywords may be displayed. A font characteristic used to display a particular keyword of the ranked keywords may be determined based at least partly on the TF-IDF value associated with the particular keyword.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Employee profiles in an enterprise may be used for employment and career advancement and to manage employee skills. The value derived from employee profiles is based, to a large extent, on the information in the employee profiles being kept accurate and up-to-date. Unfortunately, employee profiles typically rely on each employee to update their corresponding profile. Because employees are busy, employee profiles typically are not updated frequently and often remain unchanged from when the employees were originally hired. In addition, even frequently updated employee profiles may offer a superficial overview of each employee's skillset.

### SUMMARY

This Summary provides a simplified form of concepts that are further described below in the Detailed Description. This Summary is not intended to identify key or essential features and should therefore not be used for determining or limiting the scope of the claimed subject matter.

Systems and techniques for determining an expertise of an employee in an enterprise are described. A crawler may examine one or more external data sources that are external to an enterprise network associated with the enterprise to identify one or more documents associated with the employee. The external data sources may include patent databases, technical paper databases, and the like. A classifier may be used to determine keywords in the one or more documents. For each of the keywords, a term frequency-inverse document frequency (TF-IDF) value may be determined. The keywords may be ranked based at least in part on the TF-IDF value associated with each keyword to create ranked keywords. The ranked keywords may be displayed. A font characteristic used to display a particular keyword of the ranked keywords may be determined based at least partly on the TF-IDF value associated with the particular keyword.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of an architecture that includes automatically generated employee profiles according to some embodiments.

FIG. 2 is a block diagram of an architecture that includes a data gathering system according to some embodiments.

FIG. 3 is a block diagram of an architecture that includes an employee profile according to some embodiments.

FIG. 4 is a flowchart of a process that includes displaying a timeline according to some embodiments.

FIG. 5 illustrates an exemplary process to build and train a classifier according to some embodiments.

FIG. 6 illustrates an example configuration of a computing device that may be used to implement the systems and techniques described herein.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

The system and techniques described herein may automatically generate and update employee profiles for employees in an enterprise. Each employee profile may capture details, such as vocational knowledge, social and communication skills, personal competence, and the employee's reach and influence in the industry. The employee profile may be used in business processes, such as creating relevant training programs, aligning mentors with mentees, creating an accurate employee skills inventory, increasing productivity by matching employee skills to the work to be done in a project, employee performance management, developing greater management agility in a distributed workforce, etc. The systems and techniques may thus benefit both employees and their corresponding employer (e.g., the enterprise).

The systems and techniques may use a system that examines data sources, such as employee communications, to determine each employee's level of expertise. The data sources may include internal (e.g., enterprise) data sources, such as communication systems, such as Microsoft® Exchange®, Lync®/Skype®, Office365®, phone systems (e.g., using voice over internet protocol (VoIP)), human resources systems, enterprise resource planning (ERP) systems, customer relationship management (CRM) systems, etc. and external data sources, such as papers published at conferences, papers published by professional organizations (e.g., Institute of Electrical and Electronic Engineers (IEEE), Association for Computing Machinery (ACM), etc.), patent applications in patent databases (e.g., www.uspto.gov, www.epo.org, etc.), social networking sites (e.g., LinkedIn®), etc.

A data gathering component may include one or more automated web crawler(s) that crawl enterprise data resources, external data resources, or both. The data gathering component may access the enterprise's directory service (e.g., Active Directory or similar service) to determine a list of current employees. The web crawler(s) may cycle through employee identifiers and send requests to the data gathering component to retrieve expertise data associated with each employee identifier. The types of data retrieved may be varied and may include expertise areas that the data gathering component has identified as relevant to the enterprise. For example, the data gathering component may gather expertise data associated with each employee identifier, such as, areas of expertise, depth of expertise, breadth of expertise, scope of contacts (e.g., internal contacts and external contacts), authored content (e.g., PowerPoint documents, training documents, conference papers, etc.), demographics, performance records, awards, patent applications, certifications, association memberships, etc. In some cases, the data gathering component may gather data associated with non-work related interests.

The data gathering component may use the expertise data (e.g., gathered by a crawler) to populate a master employee profile (e.g., XML template) associated with each employee. Each master employee profile may be formatted and rendered for review. A user interface may enable a user to view and edit the information in a particular profile. Editing the information in an employee profile may be subject to permissions/credentials to prevent unauthorized access, e.g., only the employee, the employee's supervisor or manager, or a human resources employee may be given permission/credentials to edit the employee's profile. The user interface may enable additional information (e.g., self-contributed information) to be added in addition to the expertise data that was automatically gathered and updated. The master employee profile may make the profile data available to external applications, such as human resources systems, customer relationship management (CRM) systems, collaboration systems (e.g., SharePoint), email systems (e.g., Exchange), etc. The employee profiles may use a markup language (e.g., XML) such that the data gathering system may gather data based on the markup language. Thus, the data gathering component may leverage an enterprise's existing information technology (IT) infrastructure to benefit skills management.

The employee profiles may be used for a variety of purposes. For example, when assembling a team to create a particular product, a team manager may search the employee profiles to identify employees having the expertise and skill sets associated with the particular product. As another example, managers or human resources professionals may use an employee profile to identify training to address gaps in skills or skill development for a particular employee. As a further example, an employee encountering a problem associated with a product (e.g., during development or after deployment) may search employee profiles to identify other employees having a skillset suited to solve the problem.

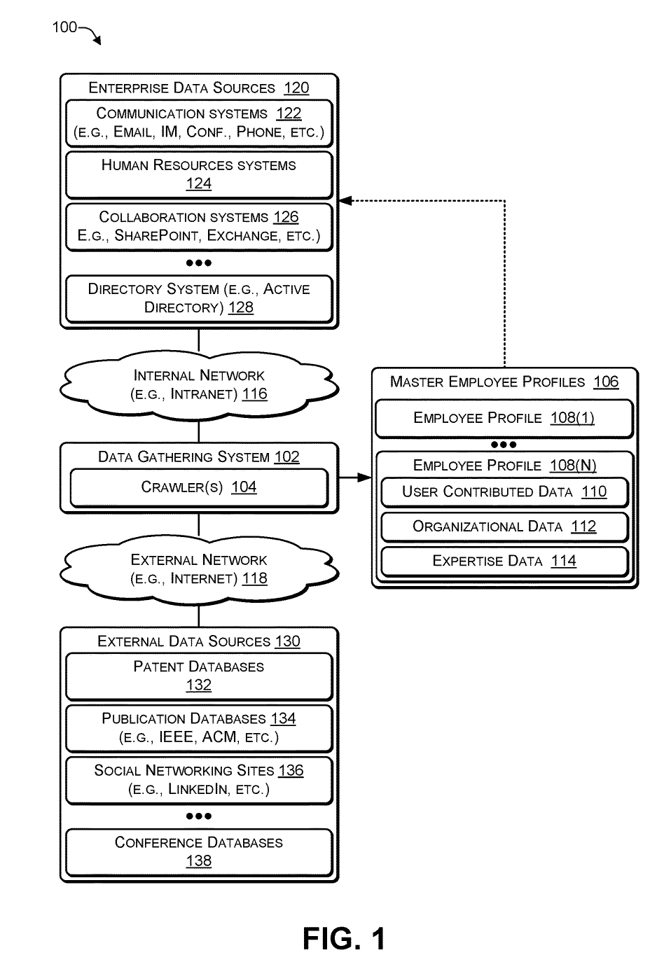

FIG. 1 is a block diagram of an architecture 100 that includes automatically generated employee profiles according to some embodiments. A data gathering system 102 may use one or more web crawlers 104 to retrieve data from an internal network (e.g., intranet) 116, an external network (e.g., Internet) 118, or both. The data gathered by the data gathering system 102 may be used to populate master employee profiles 106, e.g., including an employee profile 108(1) to an employee profile 108(N) (where N>1). Each of the employee profiles 108 may include user contributed data 110, organizational data 112, and expertise data 114. The user contributed data 110 may include information, such as personal information (e.g., hobbies, interests, etc.) provided by the employee that is associated with the employee profile 108(N). The organizational data 112 may include organizational information gathered by the data gathering system 102 via the internal network 116, such as a current position (e.g., software architect) in the organization, zero or more people (e.g., subordinates) who report to the employee, zero or more people in the same group (e.g., peers) as the employee, and one or more people to whom the employee reports (e.g., the employee's supervisor or manager). The organizational data 112 may include past (e.g., historical) data, such as projects that the employee previously worked on, previous positions, previous subordinates, previous managers, etc.

The expertise data 114 may include expertise information gathered from enterprise data sources 120, including information gathered from corporate communication systems 122, human resources systems 124, collaboration systems 126, a directory system (e.g., Active Directory) 128, other corporate systems (e.g., CRM, etc.), or any combination thereof. The communications systems 122 may include email applications (e.g., Outlook®, Lotus® Notes, etc.), instant messaging services (e.g., Microsoft® Messenger etc.), audio and/or video conferencing (e.g., Skype® etc.), phone systems (e.g., using Voice over IP (VoIP) or other technologies), other types of communications systems, or any combination thereof. Data may be extracted from the communications systems 122 using a software product, such as Dell® Unified Communications Command Suite (UCCS), that monitors and archives corporate communications and is capable of extracting data from the corporate communications. The human resources systems 124 may include Human Resources Management Systems (HRMS) (also known as Human Resources Information Systems (HRIS)) that include software functionality to manage payroll, recruitment, storing and providing access to employee information, keeping attendance records and tracking absenteeism, performance evaluations, benefits administrations, training management, employee self-service, employee scheduling, etc. The collaboration systems 126 may include systems used to facilitate the efficient sharing of documents and knowledge between teams and individuals in an enterprise (e.g., Microsoft® Exchange, SharePoint® etc.). Employee emails, instant messages, and other corporate communications may be analyzed (e.g., using a machine learning algorithm such as classifier) to determine an expertise of each employee. For example, a particular employee may have an expertise in machine learning algorithms. Other employees may send questions in communications, such as emails, instant messages, etc. to the particular employee. The particular employee may respond to the questions by sharing his expertise in machine learning. By analyzing the employee's communications, the employee's breadth and depth of expertise may be determined. For example, the depth of expertise may be determined based on how many words are included in the employee's responses, e.g., a relatively few number of words may indicate a relatively shallow depth of knowledge while a larger number of words may indicate greater depth of knowledge. The breadth of expertise may be determined based on how many different questions in the area of machine learning to which the employee responds. For example, if the particular employee receives five questions in different areas of machine learning, and three of the answers have a relatively few number of words but two of the answers, both of which are in related areas, have a larger number of words, then the particular employee may not have a very broad expertise in the topic of machine learning. In contrast, if the particular employee receives the five questions, and all five responses have a larger number of words, then the particular employee may have relatively broad knowledge in the topic of machine learning. Similar to how corporate communications are analyzed, internal documents (e.g., Word®, PowerPoint®, etc.) produced by the employee and stored in a document database (e.g., ShaePoint®) may be analyzed to determine the employee's expertise, including breadth of expertise and depth of expertise.

The expertise data 114 may include expertise information gathered from external data sources 130, such as, for example, patent databases 132 (e.g., provided by the United States Patent and Trademark Office (USPTO), the European Patent Office (EPO), etc.), publication databases 134 that include technical papers (e.g., published by organizations such as the Institute of Electrical and Electronic Engineers (IEEE), Association for Computing Machinery (ACM), etc.), social networking sites 136 (e.g., LinkedIn®, etc.), and conference databases 138 that include papers presented at conferences. Patent applications, technical papers, and other documents may be analyzed using a classifier or other machine learning algorithm to determine each employee's area of expertise, the employee's depth of expertise, the employee's breadth of expertise, etc.

At least some of the data included in the master employee profiles 106 may feed into the enterprise data sources 120. For example, the master employee profiles 106 may feed into the human resources systems 124 to provide a view of each employee's skill set that includes information extracted from the external data sources 130. In this way, employee development, training, compensation, etc. may be based on a more complete skill set profile of each employee.

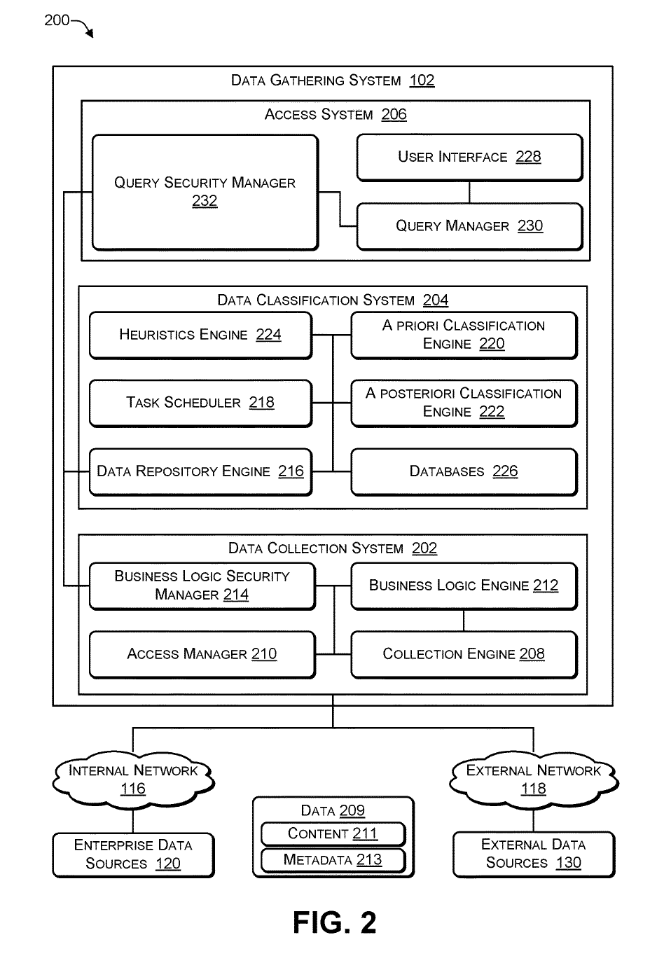

FIG. 2 is a block diagram of an architecture 200 that includes a data gathering system according to some embodiments. The data gathering system 102 may include a data collection system 202, a data classification system 204, and an access system 206.

The data collection system 202 may collect data from the enterprise data sources 120, the external data sources 130, or both. The data collection system 202 may include a collection engine 208, an access manager 210, a business logic engine 212, and a business logic security manager 214.

The collection engine 208 may access the enterprise data sources 120 to access data (e.g., data 209) that is stored by or generated by the enterprise data sources 120. This data may include data (e.g., emails, voicemails, instant messages, documents, etc.) that may be created, accessed, or received by a user or in response to the actions of a user in the enterprise. The collection engine 208 may access data (e.g., the data 209) from the external data sources 130. In some cases, the data 209 gathered from one of the resources 120, 130 may include content 211 and metadata 213. For example, when the collection engine 208 accesses a file server, the data 209 may include the metadata 213 associated with the files stored on the file server, such as the file name, file author, file owner, time created, last time edited, etc.

In some cases, at least one data source of the enterprise data sources 120 or the external data sources 130 may provide the data collection system 202 with access to data after the data collection system 202 has been authenticated. Authentication may be required for a number of reasons. For example, the data source may provide individual accounts to users, such as a social networking account, an email account, or a collaboration system account. As another example, the data source may provide different features based on the authorization level of a user. For example, a billing system may be configured to allow all employees of an organization to view invoices, but to only allow employees of the accounting department to modify invoices.

For data sources that require authentication, the access manager 210 may facilitate access by managing credentials for accessing the data sources. For example, the access manager 210 may store and manage user names, passwords, account identifiers, certificates, tokens, and other access related credentials used to access accounts associated with one or more of the enterprise data sources 120, or the external data sources 130. For instance, the access manager 210 may have access to credentials associated with a business's Facebook™ or Twitter™ account. As another example, the access manager 210 may have access to credentials associated with an LDAP directory, a file management system, or employee work email accounts.

In some embodiments, the access manager 210 may have credentials or authentication information associated with an administrative account or super user account to enable access to all of the user accounts, e.g., without requiring credentials or authentication information associated with individual user accounts. The collection engine 208 may use the access manager 210 to access the data sources 120, 130.

The business logic engine 212 may include algorithms to modify or transform the data 209 collected by the collection engine 208 into a standardized format. In some embodiments, the standardized format may be based on the data source accessed and/or the type of data accessed. For example, the business logic engine 212 may use a first format for data associated with emails, a second format for data associated with documents (e.g., Word®, PowerPoint®, Excel® etc.), a third format for data associated with web pages, and so on. Each type of data may be formatted consistently, e.g., data associated with product design files may be transformed into a common format even when the product design files are of different types. As another example, suppose that the business logic engine 212 is configured to record time using a 24-hour clock format. If one email application records the time an email was sent using a 24-hour clock format, and a second email application uses a 12-hour clock format, the business logic engine 212 may reformat the data from the second email application to use a 24-hour clock format.

In some embodiments, a user may define the format for processing and storing different types of data. In other embodiments, the business logic engine 212 may identify a standard format to use for each type of data based on, for example, the format that is most common among similar types of data sources, the format that reduces the size of the information, etc. The business logic security manager 214 may implement security and data access policies for data accessed by the collection engine 208. In some cases, the business logic security manager 214 may apply the security and data access policies to data before the data is collected as part of a determination as to whether to collect particular data. For example, an organization may designate a private folder or directory for each employee and the data access policies may include a policy to not access any files or data stored in the private directory. In some cases, the business logic security manager 214 may apply the security and data access policies to data after it is collected by the collection engine 208. Further, in some cases, the business logic security manager 214 may apply the security and data access policies to the abstracted and/or reformatted data produced by the business logic engine 212. For example, suppose the organization associated with the data gathering system 102 has adopted a policy of not collecting emails designated as personal. In this example, the business logic security manager 214 may examine email to determine whether it is addressed to an email address designated as personal (e.g., email addressed to family members) and if the email is identified as personal, the email may be discarded by the data collection system 202 or not processed any further by the data gathering system 102.

In some embodiments, the business logic security manager 214 may apply a set of security and data access policies to data or metadata provided to the data classification system 204 for processing and storage. These security and data access policies may include any policy for regulating the storage and access of data obtained or generated by the data collection system 202. For example, the security and data access policies may identify the users who may access the data provided to the data classification system 204. The determination as to which users may access the data may be based on the type of data. The business logic security manager 214 may tag the data with an identity of the users, or a class or a role of users (e.g., mid-level managers and more senior) who may access the data. As another example, of a security and data access policy, the business logic security manager 214 may determine how long the data may be stored by the data classification system 204 based on, for example, the type of data or the source of the data.

After the data collection system 202 has collected and, in some cases, processed the data 209 obtained from the enterprise data sources 120 and/or the external data sources 130, the data 209 may be provided to the data classification system 204 for further processing and storage. The data classification system 204 may include a data repository engine 216, a task scheduler 218, an a priori classification engine 220, an a posteriori classification engine 222, a heuristics engine 224 and a set of one or more databases 226.

The data repository engine 216 may index the data 209 received from the data collection system 202. The data repository engine 216 may store the data 209, including the associated index, in the set of databases 226. In some cases, the set of databases 226 may store the data 209 in a particular database of the databases 226 based on factors such as, for example, the type of the data 209, the source of the data 209, or the security level or authorization class associated with the data 209, the class of users who may access the data 209, another characteristic of the data 209, or any combination thereof.

The set of databases 226 may be dynamically expanded and, in some cases, the set of databases 226 may be dynamically structured. For example, if the data repository engine 216 receives a new type of data that includes metadata fields not supported by the existing databases of the set of databases 226, the data repository engine 216 may create and initialize a new database that includes the metadata fields as part of the set of databases 226. For instance, suppose the organization associated with the data gathering system 102 creates a first social media account for the organization to expand its marketing initiatives. Although the databases 226 may have fields for customer information and vendor information, it may not have a field identifying whether a customer or vendor has indicated that they “like” or “follow” the organization on its social media page. The data repository engine 216 may create a new field in the databases 226 to store this information and/or create a new database to capture information extracted from the social media account including information that relates to the organization's customers and vendors.

The data repository engine 216 may create abstractions of and/or classify the data received from the data collection system 202 using, for example, the task scheduler 218, the a priori classification engine 220, the a posteriori classification engine 222, and the heuristics engine 224. The task scheduler 218 may manage the abstraction and classification of the data received from the data collection system 202. In some embodiments, the task scheduler 218 may be included as part of the data repository engine 216.

Data that is to be classified and/or abstracted may be supplied to the task scheduler 218. The task scheduler 218 may supply the data to the a priori classification engine 220 to classify data based on a set of user-defined, predefined, or predetermined classifications. These classifications may be provided by a user (e.g., an administrator) or may be provided by the developer of the data gathering system 102. In some cases, the predetermined classifications may include objective classifications that may be determined based on attributes associated with the data. For example, the a priori classification engine 220 may classify communications based on whether the communication is an email, an instant message, or a voice mail. As a second example, files may be classified based on the file type, such as whether the file is a drawing file (e.g., an AutoCAD™ file), a presentation file (e.g., a PowerPoint™ file), a spreadsheet (e.g., an Excel™ file), a word processing file (e.g., a Word™ file), etc. The a priori classification engine 220 may classify data at substantially near the time of collection by the collection engine 208. The a priori classification engine 220 may classify the data prior to the data being stored in the databases 226. However, in some cases, the data may be stored prior to or simultaneously with the a priori classification engine 220 classifying the data. The data may be classified based on one or more characteristics or pieces of metadata associated with the data. For example, an email may be classified based on the email address, a domain or provider associated with the email, or the recipient of the email.

In addition to, or instead of, using the a priori classification engine 220, the task scheduler 218 may provide the data to the a posteriori classification engine 222 for classification. The a posteriori classification engine 222 may determine trends associated with the collected data. The a posteriori classification engine 222 may classify data after the data has been collected and stored in the databases 226. However, in some cases, the a posteriori classification engine 222 may be used to classify data immediately after the data is collected by the collection engine 208. Data may be processed and classified or reclassified multiple times by the a posteriori classification engine 222. In some cases, the classification and reclassification of the data may occur on a continuing basis, e.g., over time. In other cases, the classification and reclassification of data may occur at specific times. For example, data may be reclassified each day at midnight, once a week, or the like. As another example, data may be reclassified each time one or more of the engines 220, 222 is modified or after the collection of new data.

In some cases, the a posteriori classification engine 222 may classify data based on one or more probabilistic algorithms based on a type of statistical analysis of the collected data. For example, the probabilistic algorithms may be based on Bayesian analysis or probabilities. Further, Bayesian inferences may be used to update the probability estimates calculated by the a posteriori classification engine 222. In some implementations, the a posteriori classification engine 222 may use machine learning techniques to optimize or update the a posteriori algorithms. In some embodiments, some of the a posteriori algorithms may determine the probability that particular data (e.g., an email) should have a particular classification based on an analysis of the data as a whole. Alternatively, or in addition, some of the a posteriori algorithms may determine the probability that particular data should have a particular classification based on the combination of probabilistic determinations associated with subsets of the data, parameters, or metadata associated with the data (e.g., classifications associated with the content of the email, the recipient of the email, the sender of the email, etc.).

For example, in the email example, one probabilistic algorithm may be based on the combination of the classification or determination of four characteristics associated with the email, which may be used to determine whether to classify the email as a personal email, or non-work related. The first characteristic may include the probability that an email address associated with a participant (e.g., sender, recipient, BCC recipient, etc.) of the email conversation is used by a single employee. This determination may be based on the email address itself (e.g., topic based versus name based email address), the creator of the email address, or any other factor that may be used to determine whether an email address is shared or associated with a particular individual. The second characteristic may include the probability that keywords within the email are not associated with peer-to-peer or work-related communications. For example, terms of endearment and discussion of children and children's activities are less likely to be included in work related communications. The third characteristic may include the probability that the email address is associated with a participant domain or a public service provider (e.g., Yahoo® email or Google® email) as opposed to a corporate or work email account. The fourth characteristic may include determining the probability that the message or email thread may be classified as conversational as opposed to, for example, formal. For example, a series of quick questions in a thread of emails, the use of a number of slang words, or excessive typographical errors may indicate that an email is likely conversational. In this example, the a posteriori classification engine 222 may use the probabilities of the above four characteristics to determine the probability that the email communication is personal, work-related, or spam.

The combination of probabilities may not total 100%. Further, the combination may itself be a probability and the classification may be based on a threshold determination. For example, the threshold may be set such that an email is classified as personal if there is a 90% probability for three of the four above parameters indicating the email is personal (e.g., email address is used by a single employee, the keywords are not typical of peer-to-peer communication, at least some of the participant domains are from known public service providers, and the message thread is conversational).

As another example of the a posteriori classification engine 222 classifying data, the a posteriori classification engine 222 may use a probabilistic algorithm to determine whether a participant of an email is a customer. The a posteriori classification engine 222 may use the participant's identity (e.g., a customer) to facilitate classifying data that is associated with the participant (e.g., emails, files, etc.). To determine whether the participant should be classified as a customer, the a posteriori classification engine 222 may examine a number of parameters, such as a relevant Active Directory Organizational Unit (e.g., sales, support, finance, or the like) associated with the participant and/or other participants in communication with the participant, the participant's presence in forum discussions, etc. In some cases, characteristics used to classify data may be weighted differently as part of the probabilistic algorithm. For example, email domain may be a poor characteristic to classify a participant in some cases because the email domain may be associated with multiple roles. For instance, Microsoft® may be a partner, a customer, and a competitor.

In some implementations, a user (e.g., an administrator) may define the probabilistic algorithms used by the a posteriori classification engine 222. For example, if customer Y is a customer of business X, the management of business X may be interested in tracking the percentage of communication between business X and customer Y that relates to sales. Further, suppose that a number of employees from business X and a number of employees from business Y are in communication via email. Some of these employees may be in communication to discuss sales. However, it is also possible that some of the employees may be in communication for technical support issues, invoicing, or for personal reasons (e.g., a spouse of a business X employee may work at customer Y). Thus, in this example, to track the percentage of communication between business X and customer Y that relates to sales the user may define a probabilistic algorithm that classifies communications based on the probability that the communication relates to sales. The algorithm for determining the probability may be based on a number of pieces of metadata associated with each communication. For example, the metadata may include the sender's job title, the recipient's job title, the name of the sender, the name of the recipient, whether the communication identifies a product number or an order number, the time of communication, a set of keywords in the content of the communication, etc.

Using the a posteriori classification engine 222, data may be classified based on metadata associated with the data. For example, the communication in the above example may be classified based on whether it relates to sales, supplies, project development, management, personnel, or is personal. The determination of what the data relates to may be based on any criteria. For example, the determination may be based on keywords associated with the data, the data owner, the data author, the identity or roles of users who have accessed the data, the type of data file, the size of the file, the data the file was created, etc.

In certain embodiments, the a posteriori classification engine 222 may use the heuristics engine 224 to facilitate classifying data. Further, in some cases, the a posteriori classification engine 222 may use the heuristics engine 224 to validate classifications, to develop probable associations between potentially related content, and to validate the associations as the data collection system 202 collects more data. In certain embodiments, the a posteriori classification engine 222 may base the classifications of data on the associations between potentially related content. In some implementations, the heuristic engine 224 may use machine learning techniques to optimize or update the heuristic algorithms.

In some embodiments, a user (e.g., an administrator) may verify whether the data or metadata has been correctly classified. Based on the result of this verification, in some cases, the a posteriori classification engine 222 may correct or update one or more classifications of previously processed or classified data. Further, in some implementations, the user may verify whether two or more pieces of data or metadata have been correctly associated with each other. Based on the result of this verification, the a posteriori classification engine 222 using, for example, the heuristics engine 224 may correct one or more associations between previously processed data or metadata. Further, in certain embodiments, one or more of the a posteriori classification engine 222 and the heuristics engine 224 may update one or more algorithms used for processing the data provided by the data collection system 202 based on the verifications provided by the user.

In some embodiments, the heuristics engine 224 may be used as a separate classification engine from the a priori classification engine 220 and the a posteriori classification engine 222. Alternatively, the heuristics engine 224 may be used in concert with one or more of the a priori classification engine 220 and the a posteriori classification engine 222. Similar to the a posteriori classification engine 222, the heuristics engine 224 generally classifies data after the data has been collected and stored at the databases 226. However, in some cases, the heuristics engine 224 may also be used to classify data immediately after the data is collected by the collection engine.

The heuristics engine 224 may use a heuristic algorithm for classifying data. For example, the heuristics engine 224 may determine one or more characteristics associated with the data and classify the data based on the characteristics. For example, data that mentions a product, includes price information, addresses (e.g., billing and shipping addresses), and quantity information may be classified as sales data. In some cases, the heuristics engine 224 may classify data based on a subset of the characteristics. For example, if a majority or two-thirds of characteristics associated with a particular classification are identified as existing in a set of data, the heuristics engine 224 may associate the classification with the set of data. In some cases, the heuristics engine 224 may determine whether one or more characteristics are associated with the data. Alternatively, or in addition, the heuristics engine 224 may determine the value or attribute of a particular characteristic associated with the data. The value or attribute of the characteristic may then be used to determine a classification for the data. For example, one characteristic that may be used to classify data is the length of the data. For instance, in some cases, a long email may make one classification more likely that a short email.

The a priori classification engine 220 and the a posteriori classification engine 222 may store the data classification in the databases 226. Further, the a posteriori classification engine 222 and the heuristics engine 224 may store the probable associations between potentially related data at the databases 226. In some cases, as classifications and associations are updated based on, for example, user verifications or updates to the a posteriori and heuristic classification and association algorithms, the data or metadata stored in the databases 226 may be modified to reflect the updates.

Users may communicate with the data gathering system 102 using a client computing device. In some cases, access to the data gathering system 102, or to some features of the data gathering system 102, may be restricted to users who are using specific client devices. In some cases, a user may access the data gathering system 102 to verify classifications and associations of data by the data classification system 204. In addition, in some cases, at least some users may access at least some of the data and/or metadata stored at the data classification system 204 using the access system 206. The access system 206 may include a user interface 228, a query manager 230, and a query security manager 232.

The user interface 228 may enable a user to query and display the data gathered and stored by the data gathering system 102. For example, the user interface 228 may enable the user to submit a query to the data gathering system 102 to access the data or metadata stored at the databases 226. The query may be based on any number of or type of data or metadata fields or variables. By enabling a user to create a query based on multiple type of fields, the user may create complex queries. Further, because the data gathering system 102 may collect and analyze data from a number of internal and external data sources, a user of the data gathering system 102 may extract data that is not typically available by accessing a single data source. For example, a user may query the data gathering system 102 to locate all personal messages sent by the members of the user's department within the last month. As a second example, a user may query the data gathering system 102 to locate all helpdesk requests received in a specific month outside of business hours that were sent by customers from Europe. As an additional example, a product manager may create a query to examine customer reactions to a new product release or the pitfalls associated with a new marketing campaign. The query may return data that is based on a number of sources including, for example, emails received from customers or users, Facebook® posts, Twitter® feeds, forum posts, quantity of returned products, etc.

Further, in some cases, a user may create a relatively simple query to obtain a high-level view of an organization's knowledge compared to systems that are incapable of integrating the potentially large number of information sources used by some businesses or organizations. For example, a user may query the data gathering system 102 for information associated with customer X over a time period. In response, the data gathering system 102 may provide the user with information associated with customer X over the time period, which may include who communicated with customer X, the percentage of communications relating to specific topics (e.g., sales, support, etc.), the products designed for customer X, the employees who performed any work relating to customer X and the employees' roles, etc. The information provide in response to the user's query may not be provided by a single data source but rather by multiple data sources. For example, the communications may be obtained from an email server, the products may be identified from product drawings, and the employees and their roles may be identified by examining who accessed specific files in combination with the employees' human resources (HR) records.

The query manager 230 may enable the user to create and submit a query. The query manager 230 may present the available types of search parameters for searching the databases 226 to a user via the user interface 228. The search parameter types may include different types of search parameters that may be used to form a query for searching the databases 226. For example, the search parameter types may include names (e.g., employee names, customer names, vendor names, etc.), data categories (e.g., sales, invoices, communications, designs, miscellaneous, etc.), stored data types (e.g., strings, integers, dates, times, etc.), data sources (e.g., internal data sources, external data sources, communication sources, sales department sources, product design sources, etc.), dates, etc. In some cases, the query manager 230 may also parse a query provided by a user. In some cases, some queries may be provided using a text-based interface or using a text-field in a Graphical User Interface (GUI). In such cases, the query manager 230 may be configured to parse the query.

Further, the query manager 230 may cause any type of additional options for querying the databases 226 to be presented to the user via the user interface 228. These additional options may include, for example, options relating to how query results are displayed or stored.

In some cases, access to the data stored in the data gathering system 102 may be limited to specific users or specific roles. For example, access to the data may be limited to “John Smith” or to senior managers. Further, some data may be accessible by some users, but not others. For example, sales managers may be limited to accessing information relating to sales, invoicing, and marketing, technical managers may be limited to accessing information relating to product development, design and manufacture, and executive officers may have access to both types of data, and possibly more. In certain embodiments, the query manager 230 may limit the search parameter options that are presented to a user for forming a query based on the user's identity and/or role.

The query security manager 232 may include any system for regulating who may access the data or subsets of data. The query security manager 232 may regulate access to the databases 226 and/or a subset of the information stored at the databases 226 based on any number and/or types of factors. For example, these factors may include a user's identity, a user's role, a source of the data, a time associated with the data (e.g., the time the data was created, a time the data was last accessed, an expiration time, etc.), whether the data is historical or current, etc.

Further, the query manager security 232 may regulate access to the databases 226 and/or a subset of the information stored at the databases 226 based on security restrictions or data access policies implemented by the business logic security manager 214. For example, the business logic security manager 214 may identify data that is “sensitive” based on a set of rules, such as whether the data mentions one or more keywords relating to an unannounced product in development. The business logic security manager 214 may label the sensitive data as sensitive and may identify which users or roles, which are associated with a set of users, may access data labeled as sensitive. The query security manager 232 may regulate access to the data labeled as sensitive based on the user or the role associated with the user who is accessing the databases 226.

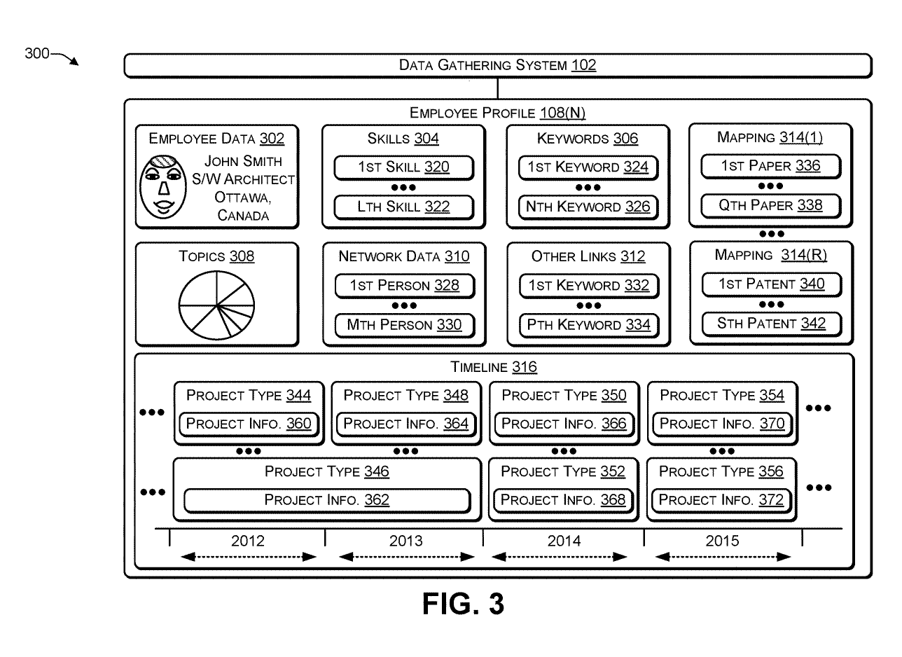

FIG. 3 is a block diagram of an architecture 300 that includes an employee profile according to some embodiments. The data gathering system 102 may enable users to search for and view employee profiles that match query criteria. For example, a user with a question on a particular aspect of cloud computing may submit a query to the user interface 228 to identify employees with knowledge about the particular aspect of cloud computing. Each employee profile, such as the employee profile 108(N), may include one or more of employee data 302, skills 304, keywords 306, a topic model 308, personal network data 310, other links 312, one or more mappings 314, and a timeline 316. The user may select an item of the items 302, 304, 306, 308, 310, 312, 314, or 316 and the item may expand into a new (or existing) window.

The employee data 302 may include the user's name, title, location (e.g., country, city, building, floor, pillar number, etc.), and other organization data, such as the employee's direct reports (e.g., subordinates), the employee's manager (or supervisor), depart number, department name, and the like.

The skills 304 may include a first skill 320 to an Lth skill 322 (L>1). The skills 304 may be ranked based on an amount of expertise, e.g., the employee may have more experience in the first skill 320 (e.g., “software development”) and less experience in the Lth skill 322 (e.g., “project management”). In some cases, the employee profile 108(N) may display the employee's top X skills (e.g., X=10).

The keywords 306 may include words (or phrases, such as “cloud computing”) found in documents (e.g., conference papers, internal presentations, training documents, patent applications, etc.) associated with the employee and may include a first keyword 324 to an Nth keyword 326 (N>1). The types of documents that are analyzed to identify the keywords 306 may be set by a system administrator. For example, the keywords 306 may be determined based on patent applications for which the employee is listed as an inventor, conference papers which the employee has authored, etc.

Term frequency-inverse document frequency (TF-IDF), is a numerical statistic that ranks how important a word is to a document in a collection of documents. The TF-IDF value increases proportionally to the number of times a word appears in the document, but is offset by the frequency of the word in the corpus, which adjust for some words appearing more frequently in general. The keywords 306 may be ranked based on TF-IDF (or other frequency ranking), e.g., the first keyword 324 may have a TF-IDF value greater than the Nth keyword 326. In some cases, the employee profile 108(N) may display the top Y keywords (e.g., Y=10) based on TF-IDF rank. In some cases, a font characteristic (e.g., size, color, etc.) used to display each of the keywords 306 may be based on the TF-IDF value. For example, a first keyword with a higher TF-IDF value may be displayed with a larger font size while a second keyword with a smaller TF-IDF value may be displayed with a smaller font size.

The topics 308 may graphically depict topics in documents associated with the employee. For example, a probabilistic topic modeling algorithm (e.g., Latent Dirichlet Allocation) may be used to identify the topics 308 in documents (e.g., patents, conference papers, etc.) associated with the employee.

The network data 310 may display the employee's professional network. The network data 310 may include people that the employee has previously worked with or is currently working with, co-authors of documents (e.g., patent applications, papers, etc.), authors of documents that have been cited in papers authored by the employee, authors of documents that have cited documents authored by the employee, etc.

The other links 312 may include other internal and external professional connections. For example, if the employee is a member of a standards setting committee then the other members of the committee may be listed as connections in the other links 312. The other links 312 may also include links from professional social networking sites, such as LinkedIn® etc.

The mappings 314(1) to 314(R) (R>1) may display mappings associated with various documents associated with the employee, such as papers 336 to 338, patent applications 340 to 342, etc. The mappings 314(1) to 314(R) (R>1) may include co-authors of documents (e.g., patent applications, papers, etc.), authors of documents that have been cited in papers authored by the employee, authors of documents that have cited documents authored by the employee, etc.

The timeline 316 may display projects in which the employee has participated within a particular time period. For example, the x-axis may display a time period using a particular granularity while the y-axis may display project-related information. To illustrate, a user may submit a query specifying a particular time period, e.g., “which projects did John Smith work on from 2012 to 2015?” Project types 344, 346, 348, 350, 352, 354, and 356 may each specify a type of project associated with the employee at different times during the time period. For example, the project types 344, 346, 348, 350, 352, 354, and 356 may include a patent application project, a conference paper project, a software product project, etc. Project information 360, 362, 364, 366, 368, 370, and 372 may each provide additional information about the project. For example, for a patent application, the project information may include the title, co-inventors, when the patent application was filed, when the application issued as a patent, etc. For a conference paper, the project information may include the title, co-authors, when the paper was presented (or published), which organization (e.g., IEEE, ACM, or the like) organized the conference, etc. For a software project, the project information may include the project name, other team members, when the project was completed (or included in a commercially available product), etc.

In some cases, the project information 360, 362, 364, 366, 368, 370, and 372 may be displayed using a font characteristic (e.g., font size, font color, front type, or the like) that is based on the project information. For example, the font size may be proportional (or inversely proportion) to the number of people associated with the project, e.g., a project involving five people may use a font size larger (or smaller if inversely proportional) than a project with two people.

The user interface may enable a user to adjust a granularity of the x-axis (time period) to increase or decrease the time period that is being displayed. For example, the time period may be adjusted to a multiple year time period with a one year granularity (e.g., as illustrated in FIG. 3), display a one year time period with a one month granularity, or another time period and granularity specified by the user. The number of project types per year (or month) may include one or more projects depending on how many projects the employee was associated in the time frame. The employee may be involved in a particular project (e.g., project type 346) longer than other projects and may participate in more than one project at a time.

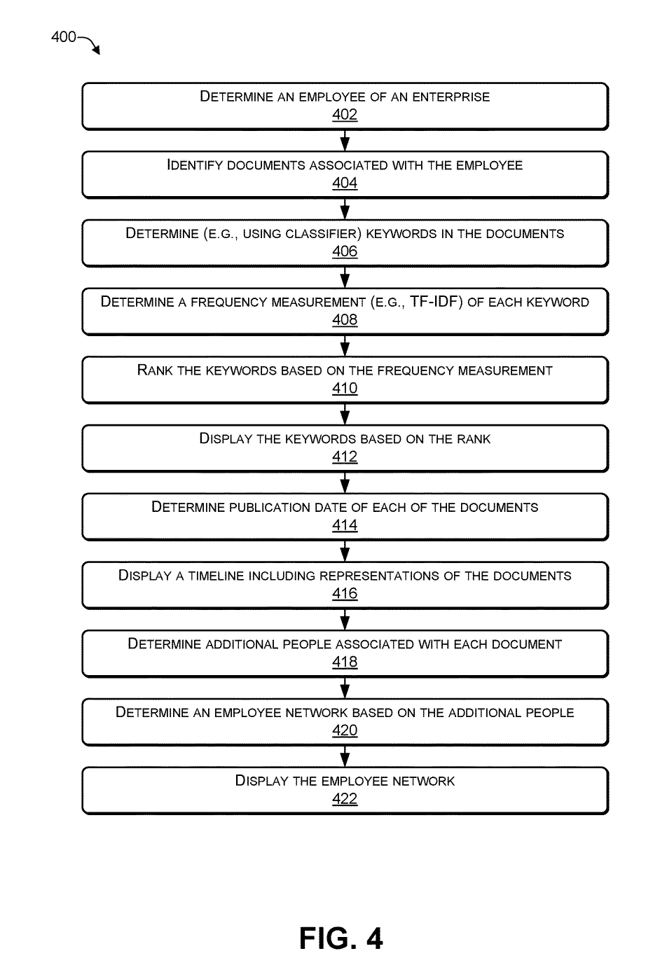

In the flow diagram of FIG. 4, each block represents one or more operations that may be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations may be combined in any order and/or in parallel to implement the processes. For discussion purposes, the process 400 is described with reference to FIG. 1, 2, or 3 as described above, although other models, frameworks, systems and environments may implement these processes.

FIG. 4 is a flowchart of a process 400 that includes displaying a timeline according to some embodiments. The process 400 may be performed by one or more components of the data gathering system 102 of FIGS. 1, 2, and 3.

At 402, an employee of an enterprise may be determined. At 404, documents associated with the employee may be identified. For example, in FIG. 1, the crawlers 104 may determine an employee of an enterprise based on an internal directory system (e.g., Active Directory® or similar). The data gathering system 102 may use the crawlers 104 to identify documents associated with the employee, including documents from the external data sources 130 and documents from the internal data sources 120.

At 406, keywords in the documents may be identified. At 408, for each of the keywords, a frequency measurement value (e.g., TF-IDF or another type of frequency measurement) may be determined. For example, in FIG. 2, the data classification system 204 may be used to identify and classify keywords in each document. The data classification system 204 may determine a frequency measurement value, such as TF-IDF, for each keyword and store the keyword, along with the corresponding frequency measurement value, in the databases 226.

At 410, the keywords may be ranked based on each keyword's frequency measurement value. At 412, the keywords may be displayed based on each keyword's rank. For example, in FIG. 3, the data gathering system 102 may rank the keywords 306 according to an each keyword's frequency measurement value and display at least a portion (e.g., top X) of keywords 306 based on the rank (e.g., based on each keyword's frequency measurement value).

At 414, a publication date of each document may be determined. At 416, a timeline that includes graphical representations corresponding to the documents may be displayed. For example, in FIG. 3, the data gathering system 102 may display the timeline 316 in which the x-axis represents a time period and the y-axis displays various project types, including patents, technical papers, product development projects, etc. Projects may be positioned along the timeline according to project information, such as a publication date associated with documents (e.g., patent applications, technical papers, etc.) or a completion data associated with product development projects.

At 418, additional people associated with each document may be determined. At 420, an employee network of the employee may be determined based on the additional people. At 422, the employee network may be displayed. For example, in FIG. 3, the data gathering system 102 may determine co-authors of technical papers, co-inventors of patent applications, other team members of projects etc. The data gathering system 102 may determine authors whose documents (e.g., technical papers, patents, etc.) have been cited by documents for which the employee is an author. The data gathering system 102 may determine authors whose documents cite documents for which the employee is an author. The data gathering system 102 may determine people in the employee's network based on connections on a social networking site, such as LinkedIn®. The data gathering system 102 may display the employee's professional network, including co-authors of documents, authors of documents cited by documents authored by the employee, authors of documents that the documents authored by the employee cite, etc.

Thus, a data gathering system may gather data that is associated with an employee from both external data sources and enterprise (e.g., internal) data sources. Any type of data that may be used to determine keywords associated with the employee's technical expertise may be used, including technical papers, patent applications, training documents, presentations, emails or instant messages (e.g., chats) in which the employee answers questions, and the like. The keywords may be classified using one or more classifiers. A frequency measurement, such as TF-IDF, may be used to determine a frequency measurement value associated with each keyword. The keywords may be displayed using a rank that is based on the frequency measurement value associated with each keyword. Graphical representations of each project (e.g., paper, patent application, or development project etc.) may be displayed on a timeline. Each project may be located on the timeline based on one or more dates associated with each project, such as a publication date or a submission date for a technical paper, a filing date or a publication date for a patent application, a start date or a completion date associated with a development project, etc. The employee's professional network may be determined and displayed, including co-authors of documents, authors of documents cited by documents authored by the employee, authors of documents that the documents authored by the employee cite, etc.

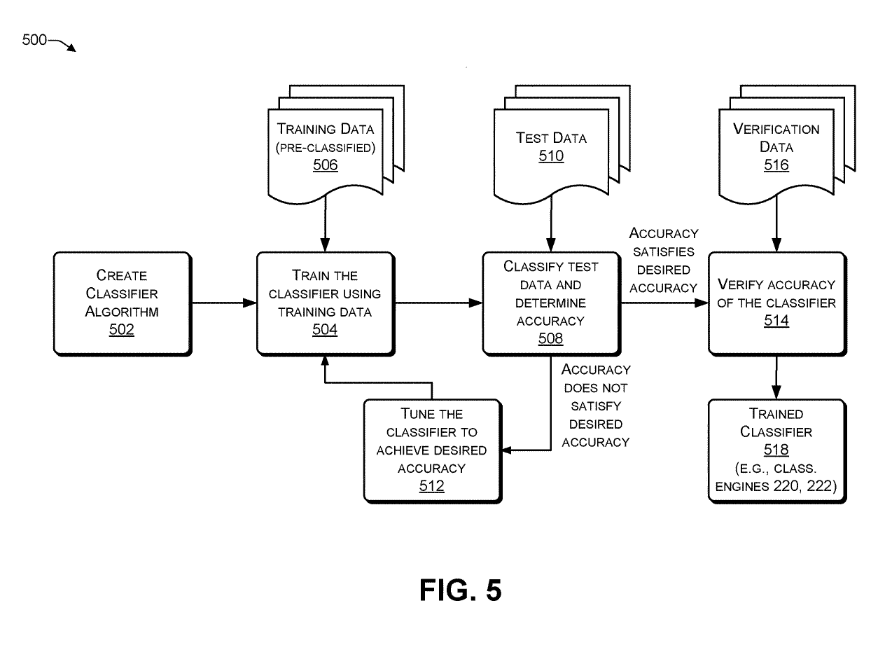

FIG. 5 illustrates an exemplary process 500 to create (e.g., build and train) a classifier, e.g., one or more components of the data classification system 204 of FIG. 2, such as, for example, the classification engines 220, 222.

At block 502, the classifier algorithm is created. For example, software instructions that implement one or more algorithms may be written to create the classifier. The algorithms may implement machine learning, pattern recognition, and other types of algorithms, using techniques such as a support vector machine, decision trees, ensembles (e.g., random forest), linear regression, naive Bayesian, neural networks, logistic regression, perceptron, or other machine learning algorithm.

At block 504, the classifier may be trained using training data 506. The training data 506 may include external documents and internal documents whose keywords have been pre-classified by a human, e.g., an expert. The external documents may include documents such as patent applications, technical papers, and the like, and the internal documents may include documents such as PowerPoint® documents, Word® documents, emails, and the like.

At block 508, the classifier may be instructed to classify test data 510. The test data 510 (e.g., keywords in documents) may have been pre-classified by a human, by another classifier, or a combination thereof. An accuracy with which the classifier 144 has classified the test data 510 may be determined. If the accuracy does not satisfy a desired accuracy, at 512 the classifier may be tuned to achieve a desired accuracy. The desired accuracy may be a predetermined threshold, such as ninety-percent, ninety-five percent, ninety-nine percent and the like. For example, if the classifier was eighty-percent accurate in classifying the test data and the desired accuracy is ninety-percent, then the classifier may be further tuned by modifying the algorithms based on the results of classifying the test data 510. Blocks 504 and 512 may be repeated (e.g., iteratively) until the accuracy of the classifier satisfies the desired accuracy.

When the accuracy of the classifier in classifying the keywords in the test data 510 satisfies the desired accuracy, at 508, the process may proceed to 514 where the accuracy of the classifier may be verified using verification data 516 (e.g., internal and external documents). The verification data 516 may have include keywords pre-classified by a human, by another classifier, or a combination thereof. The verification process may be performed at 514 to determine whether the classifier exhibits any bias towards the training data 506 and/or the test data 510. The verification data 516 may be data that are different from both the test data 510 and the training data 506. After verifying, at 514, that the accuracy of the classifier satisfies the desired accuracy, the trained classifier 518 may be used to classify keywords in internal documents and external documents. For example, the classifier 518 may identify technical keywords (e.g., “security”) and technical phrases (e.g., “cloud computing”) in internal and external documents. If the accuracy of the classifier does not satisfy the desired accuracy, at 514, then the classifier may be trained using additional training data, at 504. For example, if the classifier exhibits a bias to the training data 506 and/or the test data 510, the classifier may be training using additional training data to reduce the bias.

Thus, the classifier 518 may be trained using training data and tuned to satisfy a desired accuracy. After the desired accuracy of the classifier 518 has been verified, the classifier 518 may be used, for example, to classify keywords in documents.

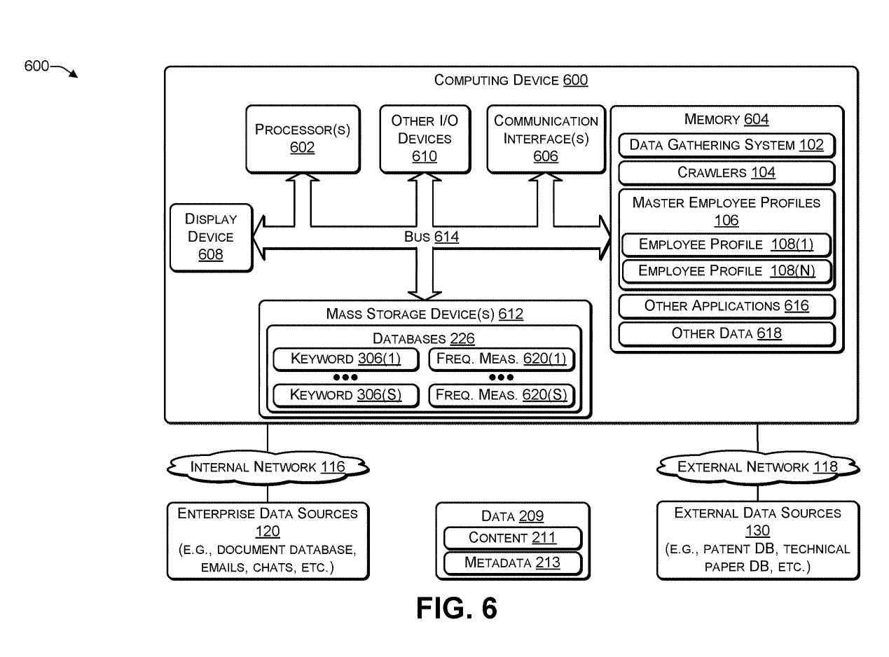

FIG. 6 illustrates an example configuration of a computing device that may be used to implement the systems and techniques described herein, such as to implement the data gathering system 102 of FIGS. 1, 2, and 3. The computing device 600 may include at least one processor 602, a memory 604, communication interfaces 606, a display device 608, other input/output (I/O) devices 610, and one or more mass storage devices 612, configured to communicate with each other, such as via a system bus 614 or other suitable connection.

The processor 602 is a hardware device that may include a single processing unit or a number of processing units, all of which may include single or multiple computing units or multiple cores. The processor 602 may be implemented as one or more microprocessors, microcomputers, microcontrollers, digital signal processors, central processing units, state machines, logic circuitries, and/or any devices that manipulate signals based on operational instructions. Among other capabilities, the processor 602 may be configured to fetch and execute computer-readable instructions stored in the memory 604, mass storage devices 612, or other computer-readable media.

Memory 604 and mass storage devices 612 are examples of computer storage media (e.g., memory storage devices) for storing instructions which are executed by the processor 602 to perform the various functions described above. For example, memory 604 may generally include both volatile memory and non-volatile memory (e.g., RAM, ROM, or the like) devices. Further, mass storage devices 612 may include hard disk drives, solid-state drives, removable media, including external and removable drives, memory cards, flash memory, floppy disks, optical disks (e.g., CD, DVD), a storage array, a network attached storage, a storage area network, or the like. Both memory 604 and mass storage devices 612 may be collectively referred to as memory or computer storage media herein, and may be a media capable of storing computer-readable, processor-executable program instructions as computer program code that may be executed by the processor 602 as a particular machine configured for carrying out the operations and functions described in the implementations herein.

The computing device 600 may also include one or more communication interfaces 606 for exchanging data via the networks 116, 118 with the enterprise data sources 120 and the external data sources 130, respectively. The communication interfaces 606 may facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), and the like. Communication interfaces 606 may also provide communication with external storage (not shown), such as in a storage array, network attached storage, storage area network, or the like. A display device 608, such as a monitor may be included in some implementations for displaying information and images to users. Other I/O devices 610 may be devices that receive various inputs from a user and provide various outputs to the user, and may include a keyboard, a remote controller, a mouse, a printer, audio input/output devices, and so forth.

The computer storage media, such as memory 604 and mass storage devices 612, may be used to store software and data. For example, the computer storage media may be used to store applications, such as the data gathering system 102, the crawlers 104, and other applications 616. The computer storage media may be used to store data, such as the master employee profiles 106, the databases 226, and other data 618. The databases 226 may be used to store the keywords 306 extracted from the data sources 120, 130. Each of the keywords 306(1) to 306(S) (S>0) may have a corresponding frequency measurement 620(1) to 620(S). For example, the frequency measurement 620 may use a simple frequency measurement, TF-IDF, or other frequency measurement.

The example systems and computing devices described herein are merely examples suitable for some implementations and are not intended to suggest any limitation as to the scope of use or functionality of the environments, architectures and frameworks that may implement the processes, components and features described herein. Thus, implementations herein are operational with numerous environments or architectures, and may be implemented in general purpose and special-purpose computing systems, or other devices having processing capability. Generally, any of the functions described with reference to the figures may be implemented using software, hardware (e.g., fixed logic circuitry) or a combination of these implementations. The term “module,” “mechanism” or “component” as used herein generally represents software, hardware, or a combination of software and hardware that may be configured to implement prescribed functions. For instance, in the case of a software implementation, the term “module,” “mechanism” or “component” may represent program code (and/or declarative-type instructions) that performs specified tasks or operations when executed on a processing device or devices (e.g., CPUs or processors). The program code may be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but may extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, software code expressed as source code in a high-level programming language such as C, C++, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that may be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various embodiments of the method and apparatus of the present invention have been illustrated herein in the Drawings and described in the Detailed Description, it will be understood that the invention is not limited to the embodiments disclosed, but is capable of numerous rearrangements, modifications and substitutions without departing from the scope of the present disclosure.

What is claimed is:

1. A computer-implemented method, comprising:
determining an employee of an enterprise;
determining, from a data source external to an enterprise network associated with the enterprise, one or more documents associated with the employee;
determining, using a classifier, keywords in the one or more documents;
determining a term frequency-inverse document frequency (TF-IDF) value associated with each of the keywords;
ranking the keywords based at least in part on the TF-IDF value associated with each of the keywords to create ranked keywords; and
displaying the ranked keywords, wherein a font characteristic used to display a particular keyword of the ranked keywords is based at least partly on the TF-IDF value associated with the particular keyword.

2. The computer-implemented method of claim 1, further comprising:
determining a publication date associated with each of the one or more documents;
displaying a timeline including one or more graphical objects, individual documents of the one or more documents corresponding to individual graphical objects of the one or more graphical objects; and
displaying, on the timeline, the individual graphical objects based at least in part on the publication date of the corresponding document of the one or more documents.

3. The computer-implemented method of claim 1, wherein the one or more documents include at least one of a conference paper or a patent application.

4. The computer-implemented method of claim 1, wherein the data source external to the enterprise network comprises one of a patent publication database or a technical publication database.

5. The computer-implemented method of claim 1, further comprising:
determining a network associated with the employee.

6. The computer-implemented method of claim 5, wherein determining the network associated with the employee comprises determining one or more additional people that are a co-author or a co-inventor associated with the one or more documents.

7. The computer-implemented method of claim 5, wherein determining the network associated with the employee comprises determining one or more additional people associated with one or more additional documents cited by the one or more documents.

8. The computer-implemented method of claim 5, wherein determining the network associated with the employee comprises determining one or more additional people associated with one or more additional documents that cite at least one document of the one or more documents.

9. One or more non-transitory computer-readable media storing instructions that are executable by one or more processors to perform operations comprising:
receiving an employee identifier that uniquely identifies an employee of an enterprise;
determining, from a data source external to an enterprise network associated with the enterprise, one or more documents associated with the employee;
determining, using a classifier, keywords in the one or more documents;
determining a term frequency-inverse document frequency (TF-IDF) value associated with each of the keywords;
ranking the keywords based at least in part on the TF-IDF value associated with each of the keywords; and
displaying the keywords, wherein a font characteristic used to display a particular keyword of the keywords is based at least partly on the TF-IDF value associated with the particular keyword.

10. The one or more non-transitory computer-readable media of claim 9, the operations further comprising:
determining a publication date associated with each of the one or more documents;
displaying one or more graphical objects corresponding to the one or more documents, the one or more graphical objects displayed on a timeline based at least in part on the publication date of a corresponding document of the one or more documents.

11. The one or more non-transitory computer-readable media of claim 9, the operations further comprising:
determining, from an internal data source in the enterprise network, additional documents associated with the employee;
determining, using the classifier, additional keywords in the additional documents;
ranking the additional keywords to create additional ranked keywords; and
displaying the additional ranked keywords.

12. The one or more non-transitory computer-readable media of claim 11, wherein the internal data source comprises one of a directory service, an internal document database, an email service, an instant messaging service, or a conferencing service.

13. The one or more non-transitory computer-readable media of claim 8, the operations further comprising:
determining a first set of people that are a co-author or a co-inventor associated with the one or more documents;
determining a second set of people associated with cited documents cited by the one or more documents;
determining a third set of people associated with one or more additional documents that cite at least one document of the one or more documents; and
displaying a network map associated with the employee based at least in part on the first set of people, the second set of people, and the third set of people.

14. A server, comprising:
one or more processors; and
one or more non-transitory computer-readable media storing instructions that are executable by the one or more processors to perform operations comprising:
retrieving an employee identifier that uniquely identifies an employee of an enterprise;
determining, from a data source external to an enterprise network associated with the enterprise, one or more documents associated with the employee;
determining, using a classifier, keywords in the one or more documents;
determining a term frequency-inverse document frequency (TF-IDF) value associated with each of the keywords;
ranking the keywords based at least in part on the TF-IDF value associated with each of the keywords to create ranked keywords; and
displaying the ranked keywords, wherein a font characteristic used to display a particular keyword of the ranked keywords is based at least partly on the TF-IDF value associated with the particular keyword.

15. The server of claim 14, the operations further comprising:
determining a publication date associated with each of the one or more documents;
displaying a timeline including one or more graphical objects, individual documents of the one or more documents corresponding to individual graphical objects of the one or more graphical objects; and
displaying, on the timeline, the individual graphical objects based at least in part on the publication date of the corresponding document of the one or more documents.

16. The server of claim 14, the operations further comprising:
determining, from an internal data source in the enterprise network, additional documents associated with the employee;
determining, using the classifier, additional keywords in the additional documents;
ranking the additional keywords to create additional ranked keywords; and
displaying the additional ranked keywords.

17. The server of claim 16, wherein the internal data source comprises one of a directory service, an internal document database, an email service, an instant messaging service, or a conferencing service.

18. The server of claim 14, the operations further comprising:
determining a first set of people that are a co-author or a co-inventor associated with the one or more documents;
determining a second set of people associated with cited documents cited by the one or more documents;
determining a third set of people associated with one or more additional documents that cite at least one document of the one or more documents; and
displaying a network map associated with the employee based at least in part on the first set of people, the second set of people, and the third set of people.

19. The server of claim 14, wherein the one or more documents include at least one of a conference paper or a patent application.

20. The server of claim 14, wherein the data source external to the enterprise network comprises one of a patent publication database or a technical publication database.
